(19) United States
(12) Patent Application Publication
(10) Pub. No.: US 2009/0111674 A1
(43) Pub. Date: Apr. 30, 2009

(54) CREASING-FOLDING MACHINE FOR PRODUCING PAPER AND BOOKBINDING ARTICLES

(76) Inventor: Giorgio Petratto, Venaria Reale (IT)

Correspondence Address: BERENATO, WHITE & STAVISH, LLC, 6550 ROCK SPRING DRIVE, SUITE 240, BETHESDA, MD, 20817, US

(21) Appl. No.: 11/719,889

(22) PCT Filed: Nov. 23, 2005
(86) PCT No.: PCT/EP2005/056179

§ 371 Date: May 22, 2007

(30) Foreign Application Priority Data
Nov. 23, 2004 (IT) T02004A000826

(51) Int. Cl. B31F 7/00

(52) U.S. Cl. 493/413

(57) ABSTRACT

A creasing-folding machine, for producing paper and bookbinding articles, has a feed unit, for feeding sheets along a feed path, a creasing unit, and a folding unit in series with one another; the creasing unit has at least one creasing roller positioned with its axis perpendicular to the feed path and having, on its lateral surface, a creasing blade extending crosswise to the feed path, and a pressure roller which cooperates with an opposite face of each sheet to the creasing roller; the creasing unit is interposed between the feed unit and the folding unit to perform continuous transverse creasing operations upstream from the folding unit.

### TECHNICAL FIELD

The present invention relates to a creasing-folding machine for producing paper and bookbinding articles, such book-covers, pamphlets, folders, brochures.

### BACKGROUND ART

A folding machine is known to be associated with a creasing unit for performing auxiliary creasing operations, i.e. forming crease lines on sheets to assist subsequent folding. Creasing is particularly necessary when working with thick sheets or sheets plastic-coated on one or both sides.

A creasing unit with a rotating circular blade is known to be located in series with a folding unit to form creases lengthwise with respect to the travelling direction of the sheets. This solution permits continuous operation, i.e. without stopping the sheets to form the creases, but is limited in scope, by not allowing for transverse creases for use on a pocket-type folding unit, and by having a tendency to damage the paper.

A creasing unit with a reciprocating blade is also known to be located upstream from the folding unit to form creases crosswise to the travelling direction of the sheets for use at the subsequent folding stage. A reciprocating-blade unit, however, calls for stopping the sheet, and the creasing operation, though excellent from the technical standpoint and variously controllable, is relatively slow and fails to make the best use of the machine's output potential.

### DISCLOSURE OF INVENTION

It is an object of the present invention to provide a creasing-folding machine for producing paper and bookbinding articles, designed to eliminate the aforementioned drawbacks typically associated with known machines.

According to the present invention, there is provided a machine as claimed in claim 1.

### BRIEF DESCRIPTION OF THE DRAWINGS

A number of preferred, non-limiting embodiments of the present invention will be described by way of example with reference to the accompanying drawings, in which:

FIG. 1 shows a schematic side view of a creasing-folding machine in accordance with the present invention;

FIG. 2 shows a schematic section, along line II-II in FIG. 1, of a first embodiment of a creasing assembly of the FIG. 1 machine;

FIG. 3 shows a section along line III-III in FIG. 2;

FIG. 4 shows a schematic section, along line II-II in FIG. 1, of a second embodiment of a creasing assembly of the FIG. 1 machine;

FIG. 5 shows a section along line V-V in FIG. 4;

FIG. 6 shows a schematic section, along line II-II in FIG. 1, of a third embodiment of a creasing assembly of the FIG. 1 machine;

FIG. 7 shows a schematic top plan view of a fourth embodiment of a creasing assembly of the FIG. 1 machine.

### BEST MODE FOR CARRYING OUT THE INVENTION

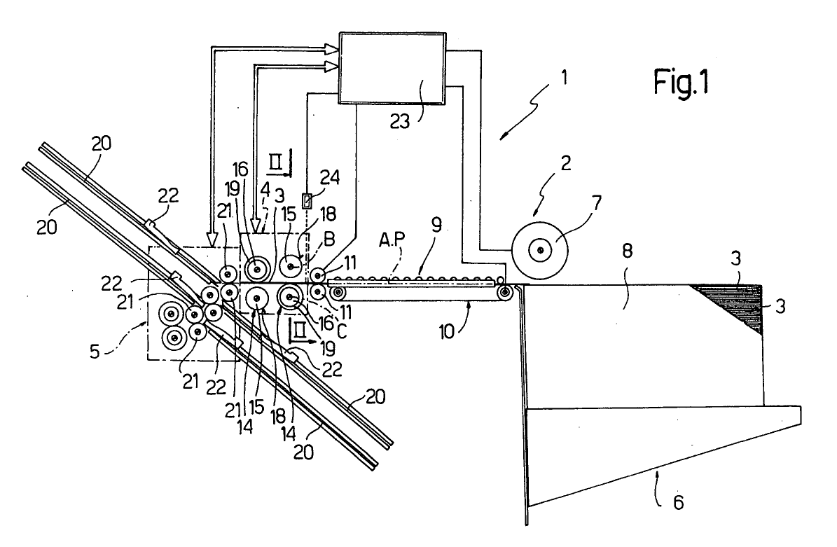

Number 1 in FIG. 1 indicates a creasing-folding machine for producing paper and bookbinding articles.

Machine 1 substantially comprises a feed unit 2 for feeding sheets 3 along a feed path A lying in a plane P; a creasing unit 4 located along path A to receive sheets 3 successively; and a folding unit 5 at the output of creasing unit 4.

Feed unit 2 is known, and therefore not described in detail, and may comprise, purely by way of a non-limiting example, a stack-type sheet loader 6; a suction roller 7 for removing sheets 3 one at a time off the stack 8 of sheet loader 6; and a squaring device 9 for squaring the sheets and employing an oblique belt 10.

At the output, immediately adjacent to creasing unit 4, feed unit 2 also comprises two traction rollers 11—at least one of which is powered—to ensure sheets 3 are fed successively to creasing unit 4 at a known travelling speed.

It should be pointed out that machine 1 may be combined in series with other machines, so that feed unit 2 may be at least partly replaced by the output assembly of an upstream machine, and simply comprise traction rollers 11.

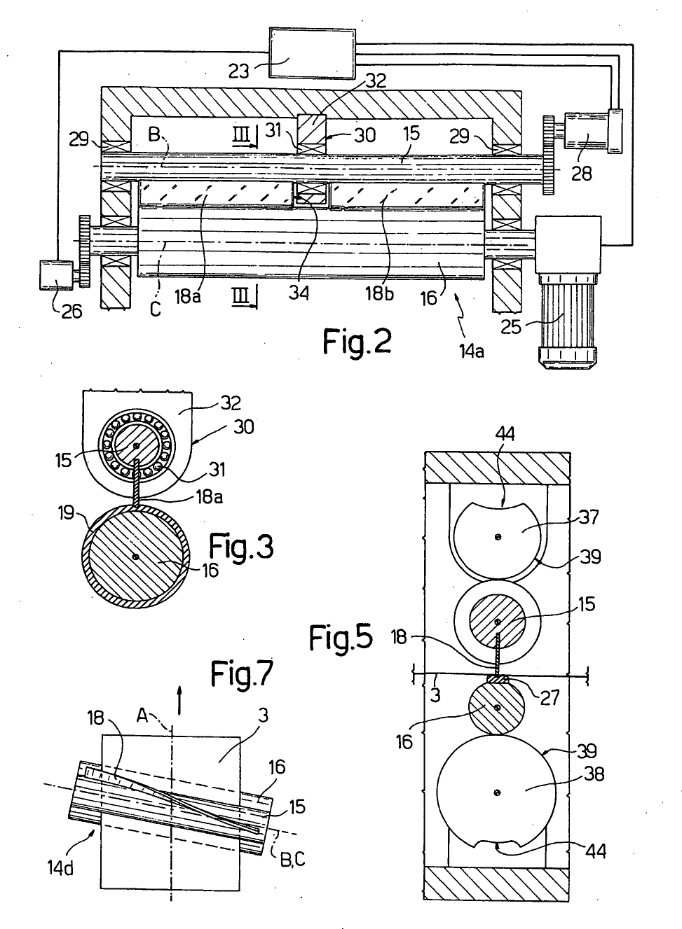

In FIG. 1, creasing unit 4 is only shown schematically as regards the main characteristics common to all the preferred embodiments, which are shown in more detail in FIGS. 2 to 6 and described individually below with reference to FIGS. 2 to 6.

Creasing unit 4 conveniently comprises two cascade creasing assemblies 14, each of which comprises a creasing roller 15 and a pressure roller 16 having parallel axes B and C and cooperating with opposite faces of sheets 3. The two creasing assemblies 14 are inverted with respect to each other, so that creasing roller 15 of one assembly is above, and the other below, plane P, to permit creasing in opposite directions, i.e. raised and recessed, and so permit folding in both directions.

Each creasing roller 15 comprises a creasing blade 18 for locally deforming the fibres of the sheet without cutting it; and pressure rollers 16 are each conveniently covered with a layer 19 of elastomeric material (FIG. 3) to form a flexible work support for sheet 3. Alternatively, rollers 16 may be fitted with dies 27 (FIG. 5) cooperating with respective blades 18.

Folding unit 5 is a conventional pocket type, and therefore not described in detail. Briefly, it comprises a number of, e.g. four, cascade pockets 20 preferably arranged in twos on opposite sides of a group of traction rollers 21 so arranged as to feed sheet 3 from one pocket to the next. Each pocket 20 comprises a diverting member 22 movable between a withdrawn position (shown in the first two pockets) and a forward position (shown in the last two pockets). In the withdrawn position, which is adjustable, diverting member 22 lets sheet 3 into the pocket, acts as a stop for a leading edge of the sheet, and forces the sheet to fold under the traction exerted by the traction rollers. In the forward position, diverting member 22 prevents the sheet from entering pocket 20, and diverts it towards traction rollers 21 of the next pocket 20 without folding it.

Feed unit 2, creasing unit 4, and folding unit 5 are controlled by a programmable control unit 23 governing overall operation of the machine. More specifically, control unit 23 is connected to an optical sensor 24 for detecting the presence of a sheet 3 at the input of creasing unit 4 and controlling creasing assemblies 14 as described in detail below.

With reference to FIGS. 2 and 3, number 14a indicates a first embodiment of a creasing assembly 14 of creasing unit 4. Creasing assembly 14a comprises a creasing roller 15 defined by a relatively small-diameter, hence low-inertia, shaft; and a solid, larger-diameter pressure roller 16 covered with a layer 19 of elastomeric material.

Pressure roller 16 is substantially rigid and only supported at the ends.

Pressure roller 16 is driven by an electric power motor 25 directly, as shown, or via a synchronous drive, e.g. a timing belt; traction rollers 11 are conveniently driven by the same motor 25 via a synchronous drive (not shown); and motor 25 is controlled by control unit 23 by means of an encoder 26, which determines the speed and angular position of roller 16 (or of another shaft connected angularly to it) and supplies control unit 23 with input signals indicating the speed and position of sheet 3.

Creasing roller 15 is driven by an independent brushless electric motor 28 with an encoder for speed and position control by control unit 23.

To prevent creasing roller 15 from bending under the work load, in addition to the usual end supports 29, an intermediate support 30 is provided, defined by a bearing 31 mounted in a bracket 32 forming part of the fixed structure of the machine. Creasing blade 18 is divided into two parts 18a, 18b located on axially opposite sides of intermediate support 30 and forming a gap 34 in between to avoid interference with support 30.

Creasing assembly 14a operates as follows.

Sheets 3 are fed in known manner along path A at a constant travelling speed defined by traction rollers 11 and pressure roller 16; the distance between sheets 3 is not controlled, and is therefore not constant.

When a sheet 3 is detected by sensor 24, brushless motor 28 is accelerated, according to a predetermined speed curve memorized in control unit 23, so that blades 18a, 18b are brought to a tip speed equal to the travelling speed of sheet 3, and to an appropriate angular position in which to interact with sheet 3 and form the crease in the predetermined position.

Creasing roller 15 being a shaft with a much lower moment of inertia than a solid roller, rapid speed transients, and therefore extremely high production speeds, can be achieved using a relatively low-power—and therefore small-size, low-inertia—brushless motor 28. Another important point to note is that, during operation, the interaction under pressure between blades 18a, 18b and pressure roller 16 results in “traction” of creasing roller 15 by pressure roller 16, so that brushless motor 28 substantially only provides, with very little power, for speed and position control. Creasing roller 15 being supported in the middle, there is substantially no bending, so that the above advantages of using a lightweight, low-inertia creasing roller 15 are achieved with no impairment whatsoever in the quality of the work. The small break in the crease produced by gap 34 between blades 18a, 18b is normally acceptable, and does not impair the quality of the folds made by unit 5.

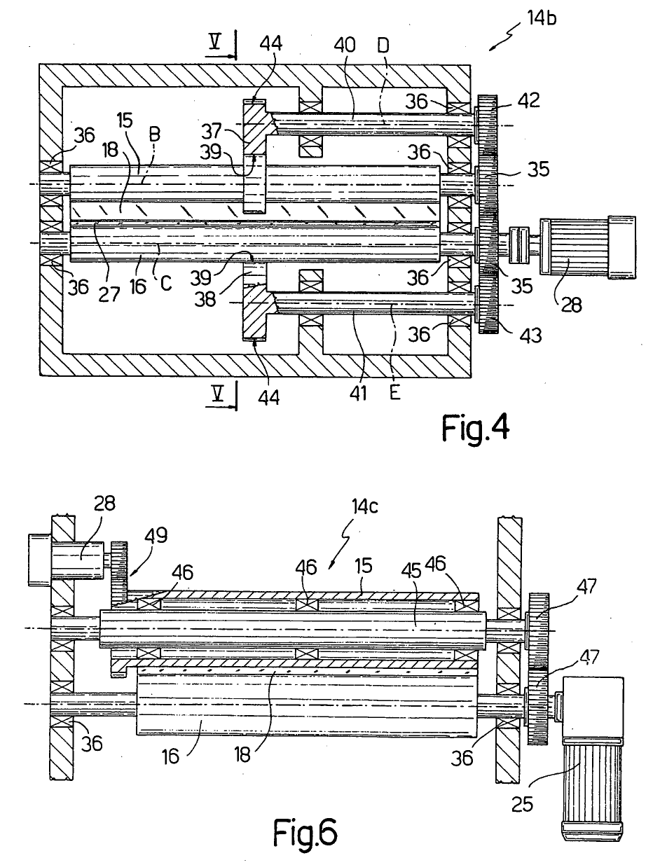

FIGS. 4 and 5 show a variation, indicated 14b, of the creasing assembly.

In assembly 14b, which is only described insofar as it differs from assembly 14a, pressure roller 16 is also as lightweight as possible, and is in the form of a relatively small-diameter shaft fitted with a creasing die 27 cooperating with creasing blade 18 which, in this case, is in one piece. Because of the presence of creasing die 27, rollers 15 and 16 are timed with respect to each other. More specifically, rollers 15, 16 are connected angularly to each other by two meshing gears 35 integral with the respective rollers.

One brushless motor 28, controlled by control unit 23, drives both rollers 15, 16, so that, in this case, roller 16 is independent of traction rollers 11.

Both creasing roller 15 and pressure roller 16 are supported at both ends by conventional bearings 36, and in the middle by opposed contrast disks 37, 38, which rotate about respective axes D, E parallel to axes B, C of rollers 15, 16, and lying in the plane defined by axes B, C, on opposite sides of rollers 15, 16. Disks 37, 38, which cooperate in contact with respective rollers 15, 16 by means of respective lateral contact surfaces 39, are supported by respective shafts 40, 41 timed with respect to rollers 15, 16 by means of respective gears 42, 43 meshing with respective gears 35. Disks 37, 38 have respective recesses 44, which form breaks on surfaces 39 to prevent interference with creasing blade 18 and die 27 respectively.

This solution has the same advantages as assembly 14a. In addition, both rollers 15, 16 are driven by a single brushless motor 28 which, given the minimum inertia of the two rollers, may be low-power; and intermediate support of rollers 15, 16 by disks 37, 38 with recesses 44 allows a one-piece creasing blade 18 and one-piece die 27 to be used.

FIG. 6 shows a creasing assembly 14c in accordance with a further variation of the invention, in which pressure roller 16 is a solid roller covered with elastomeric material, as in assembly 14a, can therefore be supported in conventional manner at the ends only by bearings 36, and is powered independently of roller 15.

Creasing roller 15 is in the form of a hollow cylinder, and is mounted idly on a supporting shaft 45 by means of bearings 46—preferably three bearings 46, two of which define end supports, and the third an intermediate support, for supporting roller 15 on shaft 45.

Creasing roller 15 is conveniently powered by a brushless electric motor 28 with an encoder, and possibly via a synchronous belt drive 49. Shaft 45 and pressure roller 16 are connected to each other, e.g. by two gears 47, and are driven by an electric motor 25 substantially more powerful than brushless motor 28, and which conveniently also drives traction rollers 11 via a synchronous drive (not shown).

Creasing roller 15 being supported internally, this solution combines the advantages of assembly 14a with the possibility of employing a one-piece creasing blade 18.

FIG. 7 shows a creasing assembly 14d in accordance with a further variation of the present invention. In assembly 14d, rollers 15, 16 have axes B, C parallel to each other and to plane P, but not perpendicular to path A of sheets 3. As opposed to being straight and extending along a generating line of the roller, as in the above embodiments, creasing blade 18 is helical, with the helix so inclined as to compensate for the tilt of the roller axis and so form on sheets 3 straight creases perpendicular to path A.

The advantage of this solution lies in blade 18 contacting sheet 3 gradually, as opposed to simultaneously along the full length of the blade, so that the reaction forces on creasing roller 15 are reduced, thus reducing bending of the roller.

Using a combination of two cascade creasing assemblies 14 of any of the types described, upstream from folding unit 5 and one inverted with respect to the other, creases can be formed in both directions and with any spacing. Given the low inertia of roller 15, and hence the possibility of easily achieving any speed profile by means of brushless motor 28, each assembly 14 can obviously act repeatedly on sheets 3 to form a number of parallel creases spaced programmable distances apart. That is, it is possible to temporarily accelerate or decelerate creasing roller 15 with respect to pressure roller 16 and traction rollers 11 (assemblies 14a, 14c), or both rollers 15, 16 with respect to traction rollers 11 (assembly 14b), according to appropriate speed profiles, to bring creasing blade 18 (and die 27, if any) into contact with the sheet after a programmable time interval. Obviously, before sheet 3 is contacted, the rotation speed of roller 15 (and of roller 16, if timed as in assembly 14b) must be brought back to a value corresponding to the travelling speed of sheet 3.

Clearly, changes may be made to machine 1, and in particular to creasing assemblies 14, as described herein without, however, departing from the protective scope as defined in the accompanying Claims.

In particular, creasing blade 18 may move along other than the circular path described, and may be carried, for example, by any mechanism capable of moving it along a non-circular path, but substantially tangent to the plane of sheet 3, in programmable manner coordinated with travel of the sheet. The term “substantially tangent” being intended to mean that the depth of the crease actually determines interference between the blade edge position envelope and the sheet plane in the strictly geometrical sense.

Creasing rollers 15 may comprise a number of blades 18, as opposed to only one; and intermediate support 30 or 46 of creasing roller 15 may even be dispensed with, if roller 15 is rigid enough to ensure acceptable bending under the work load.

1. A creasing-folding machine for producing paper and bookbinding articles, comprising feed means (2), for supplying sheets (3) and feeding said sheets (3) along a feed path (A), a creasing unit (4), and a folding unit (5) in series with one another; characterized in that the creasing unit (4) comprises at least one creasing assembly (14) having at least a creasing blade (18) crosswise to the feed path (A), supporting means (15) for supporting the creasing blade (18) and moving it along a path substantially tangent to the feed path (A) of the sheets (3), and contrasting means (16) cooperating with the sheets (3) on the opposite side to said creasing blade (18); and in that said creasing unit (4) is located upstream from the folding unit (5) to perform continuous transverse creasing operations upstream from the folding unit (5).

2. A machine as claimed in claim 1, characterized in that said supporting means for supporting said creasing blade (18) comprise a creasing roller (15), and said contrasting means comprise a pressure roller (16); said creasing roller (15) and said pressure roller (16) being positioned with their respective axes (B, C) parallel to each other, crosswise to the feed path (A) of the sheets (3), and on opposite sides of a feed plane (P), to cooperate with opposite faces of the sheets; said creasing blade (18) being located on a lateral surface of said creasing roller (15).

3. A machine as claimed in claim 2, characterized in that said creasing roller (15) is driven by a brushless electric motor (28).

4. A machine as claimed in claim 2, characterized by comprising an intermediate support (30) cooperating with said creasing roller (15) in an intermediate position along said creasing roller, to limit bending under work loads.

5. A machine as claimed in claim 4, characterized in that said intermediate support (30) comprises a bearing (31) outside said creasing roller (15).

6. A machine as claimed in claim 5, characterized in that said creasing blade (18) is interrupted at said intermediate support (30).

7. A machine as claimed in claim 4, characterized in that said intermediate support comprises a contrast disk (37), which has an axis (D) parallel to the axis (B) of the creasing roller (15), and is located on the opposite side of the creasing roller to the pressure roller (16), so as to cooperate with said creasing roller (15) along a lateral surface (39) of the contrast disk.

8. A machine as claimed in claim 7, characterized in that said contrast disk (37) is timed angularly with respect to said creasing roller (15), and has a recess (44) on said lateral surface (39) to avoid interference with said creasing blade (18).

9. A machine as claimed in claim 2, characterized in that said creasing roller (15) is a hollow cylinder mounted idly on a supporting shaft (45).

10. A machine as claimed in claim 9, characterized in that said intermediate support comprises a bearing (46) inside said creasing roller (15).

11. A machine as claimed in claim 1, characterized by further comprising a sensor (24) for detecting the presence of sheets (3) entering said creasing unit (4); and a control unit (23) for controlling said feed means (2) and said supporting means (15) supporting said creasing blade (18), so as to coordinate the movement of said creasing blade (18) with supply of the sheet (3) by said feed means (2).

12. A machine as claimed in claim 2, characterized in that said pressure roller (16) has a covering (19) of flexible material.

13. A machine as claimed in claim 2, characterized in that said pressure roller (16) is powered.

14. A machine as claimed in claim 9, characterized in that said pressure roller (16) and said supporting shaft (45) are connected angularly to each other.

15. A machine as claimed in claim 2, characterized in that said pressure roller (16) comprises a creasing die (27) cooperating with said creasing blade (18).

16. A machine as claimed in claim 15, characterized in that said creasing roller (15) and said pressure roller (16) are connected angularly to each other.

17. A machine as claimed in claim 1, characterized in that said folding unit (5) is a pocket type.
